(19) United States
(12) Patent Application Publication
(10) Pub. No.: US 2024/0260633 A1
(43) Pub. Date: Aug. 8, 2024

(54) ANTI-CAKING COMPOSITION FOR SALT

(71) Applicant: Cargill, Incorporated, Wayzata, MN (US)

(72) Inventors: Robert Scott KOEFOD, Maple Grove, MN (US); Jeanette Louise THOMAS, New Baltimore, MI (US); Leland Robert WIDGER, St. Clair, MI (US)

(73) Assignee: Cargill, Incorporated, Wayzata, MN (US)

(21) Appl. No.: 18/682,721

(22) PCT Filed: Sep. 16, 2022
(86) PCT No.: PCT/US2022/076559

§ 371 Date: Feb. 9, 2024

Related U.S. Application Data
(60) Provisional application No. 63/254,719, filed on Oct. 12, 2021.

(51) Int. Cl. A23L 29/00; A23P 10/43

(52) U.S. Cl. CPC A23L 29/035; A23L 29/015; A23P 10/43

(57) ABSTRACT

Aqueous anticaking agent solutions are prepared by mixing a ferrous source, a citrate source, a hydroxide source and water together. The ferrous source and the citrate source are present in a Fe to citrate molar ratio of from 0.5 to 1.5 and the hydroxide source is present in an amount to give a total hydroxide to citrate molar ratio of from (0.1+x) to (1.0+x), where x=the number of ionizable protons associated with the carboxylate sites on the citrate source. Alternatively, the hydroxide source is present in an amount such that the intermediate aqueous mixture has a pH at the time of mixing of at least 5. Salt is treated by applying the described aqueous anticaking agent solution in an amount effective to reduce caking of the salt.

### CROSS_REFERENCE TO RELATED APPLICATIONS

This application claims the benefit of U.S. Provisional Patent Application No. 63/254,719, filed 12 Oct. 2021, which is hereby incorporated by reference in its entirety.

### FIELD

The present invention relates to anti-caking compositions. More specifically, the present application relates to anti-caking compositions for salt.

### BACKGROUND

Sodium chloride is highly hygroscopic, and therefore is subject to caking. Anti-caking compositions have been applied to salt, such as tricalcium phosphate (“TCP”) and sodium ferrocyanide (also referred to as Yellow Prussiate of Soda or “YPS”), which are effective anti-caking agents for salt.

While there are a variety of anticaking/flow agents commonly used in sodium chloride salt, YPS is unique from other “physical” flow agents like TCP, MgCO3, SiO₂, etc. Physical flow agents are thought to act as a physical barrier and/or as a mild desiccant, coating the salt crystals and preventing surface brine layers from forming, combining and recrystallizing on adjacent salt crystals that over multiple cycles result in the formation of large solid clumps. These physical flow agents are therefore added in the low weight percent range (0.3-2 wt %) and are also necessarily water insoluble. YPS however, is a crystal habit modifier and binds in a specific geometry within the sodium chloride crystal lattice itself. It then results in a change in the crystal shape of the sodium chloride itself, forming delicate bridges that break easily upon manipulation. YPS is therefore water soluble and is effective at much lower additive levels (low ppm range). There have been only a handful of effective crystal habit modifiers of sodium chloride identified, although it is largely unclear what specific structural characteristics are responsible for their unique crystal habit modifying properties, making identifying new alternatives difficult.

While YPS is a highly effective anti-caking agent at low levels, water soluble, and approved for use in food, some customers have negative perceptions of this material and the nitrogen-containing cyano ligands are not compatible with certain applications such as electrochemical chlorine generation.

Other anti-caking compositions have been proposed, such as metal (iron, titanium and/or chromium) complexes of a hydroxypolycarboxylic acid, and in particular iron complexes of (meso)tartaric acid. See U.S. Pat. No. 6,800,263. U.S. Pat. No. 6,800,263 additionally describes preparation of an iron citrate anticaking composition from ferrous sulfate heptahydrate in sulfuric acid.

Other anti-caking compositions described in the prior art include iron ammonium hydroxypolycarboxylic acid complexes, such as Ferric Ammonium Citrate. See WO 00/73208.

### SUMMARY

The search for, and commercialization of, alternative water soluble flow agents for sodium chloride is complicated by the fact that the composition must not only be effective at preventing clumping of the salt, but is desired to be relatively inexpensive, easy to produce, safe for use in food products, and would be able to be applied to the salt in a manner that doesn't add significant complexity or cost to the manufacturing process itself. In many facilities where additives are applied to salt after the drying process, a liquid additive package (such as YPS) that is sufficiently concentrated to avoid a secondary drying step after addition would provide a significant cost advantage from both a capital and operational standpoint, and make adoption easier for the manufacturer as well as more cost effective for the customer/consumer.

It has been discovered that the performance of iron citrate solutions as an anticaking agent for salt is surprisingly impacted by selection of starting materials, mix ratios and control of process conditions in preparation of the iron citrate complex.

In an aspect, a method of making an aqueous anticaking agent solution comprises mixing a ferrous source, a citrate source, a hydroxide source and water together to form an intermediate aqueous mixture. The ferrous source and the citrate source are present in a Fe to citrate molar ratio of from 0.5 to 1.5 and the hydroxide source is present in an amount to give a total hydroxide to citrate molar ratio of from (0.1+x) to (1.0+x), where x=the number of ionizable protons associated with the carboxylate sites on the citrate source. In an aspect, the hydroxide source is present in an amount to give a total hydroxide to citrate molar ratio of from (0.5+x) to (1.0+x). The ferrous source, citrate source, and hydroxide source are present in the intermediate aqueous mixture for a time sufficient to form at least one soluble iron citrate complex to provide an aqueous anticaking agent solution.

In an aspect, a method of making an aqueous anticaking agent solution comprises mixing a ferrous source, a citrate source, a hydroxide source and water together to form an intermediate aqueous mixture. The ferrous source and the citrate source are present in a Fe to citrate molar ratio of from 0.5 to 1.5, and the hydroxide source is present in an amount such that the intermediate aqueous mixture has a pH at the time of mixing of at least 5. The ferrous source, citrate source, and hydroxide source to be present in the intermediate aqueous mixture for a time sufficient to form at least one soluble iron citrate complex to provide an aqueous anticaking agent solution.

In an aspect, the total concentration of Fe present in the aqueous anticaking agent solution made by either of these methods is at least 24,000 ppm Fe.

In an aspect, a method of making an aqueous anticaking agent solution comprises adding a hydroxide source to a solution of a ferrous source in water, collecting any resulting ferrous hydroxide precipitate and forming a suspension of the ferrous hydroxide precipitate in water. A citrate source and a second hydroxide source is added to the suspension, and an iron citrate complex solution is formed by heating (or allowing the solution to be heated by heat of reaction) the suspension such that the ferrous source and the citrate source are present in a Fe to citrate molar ratio of from 0.5 to 1.5, and the second hydroxide source is present in an amount to give a total hydroxide (including the hydroxide content from the ferrous hydroxide) to citrate molar ratio of from (0.5+x) to (1.0+x), where x=the number of ionizable protons associated with the carboxylate sites on the citrate source to form an intermediate aqueous mixture. The ferrous salt, the citrate source, and the second hydroxide source are present in the intermediate aqueous mixture for a time sufficient to form at least one soluble iron citrate complex to provide an aqueous anticaking agent solution. The total concentration of Fe present in the aqueous anticaking agent solution is at least 24,000 ppm Fe.

In an aspect, an aqueous anticaking agent solution is provided that is prepared by any of the above methods.

In an aspect, an aqueous anticaking agent solution is provided comprising at least one iron citrate complex, wherein the aqueous anticaking agent solution has a Fe to citrate molar ratio of from 0.5 to 1.0, a pH of at least 5 at the time of mixing, and the total concentration of Fe present in the aqueous anticaking agent solution is at least 24,000 ppm Fe.

In an aspect, a method of treating salt comprises providing an untreated salt composition comprising sodium chloride, and applying an aqueous anticaking agent solution as described herein to the untreated salt composition in an amount effective to reduce caking of the salt.

In an aspect, it has been found that iron citrate anticaking agents as described herein may advantageously be formulated as high concentration aqueous solutions. The methods as described herein facilitate formation of stable, soluble iron citrate complex(es) even when the complex is present in high concentration. In an aspect, delivery of the iron citrate anti-caking agent to salt from a highly concentrated solution is advantageous, because the salt is exposed to a low amount of added moisture, reducing or eliminating additional drying or special handling steps required by higher moisture addition to avoid causing clumping of the salt during the very process employed to avoid clumping/caking. In an aspect, aqueous anticaking agent solutions are provided in high concentration with low water content, thus providing savings in energy and avoidance of extra process steps as compared to compositions where an anticaking agent are delivered in a more dilute solution.

In an aspect, the aqueous anticaking agent solution has a water content in solution of from 30% to 85%. In an aspect, the aqueous anticaking agent solution has a water content in solution of from 30% to 70%. In an aspect, the aqueous anticaking agent solution has a water content in solution of from 30% to 60%. In an aspect, the aqueous anticaking agent solution has a water content in solution of from 30% to 50%. In an aspect, the aqueous anticaking agent solution has a water content in solution of from 40% to 70%. In an aspect, the aqueous anticaking agent solution has a water content in solution of from 40% to 60%. In an aspect, the aqueous anticaking agent solution has a water content in solution of from 40% to 50%.

In an aspect, the anticaking agent in the aqueous anticaking agent solution is a functionally-active iron citrate composition that is a complexation product of iron(II) and/or iron(III) with citrate ionization ≥3.5 but ≤4.0.

It has been found that deviating outside of the ranges of component content as described herein significantly decreases the effectiveness of the anti-caking agent. The solution is also prepared at a concentration that is sufficient to minimize the amount of added water upon application such to avoid the need for additional drying steps. It has been found that preparation of the solution at this concentration does not require extraordinary steps for processing, handling, and packaging of the additive solution beyond typical physical processing methods such as heating, cooling, filtration, mixing, rinsing, etc. In an aspect, the aqueous anticaking agent solution as described herein can be prepared and stored without complex processing steps such as electrochemical stabilization, strictly anaerobic preparation/storage, chromatographic separations, distillation, and combinations thereof.

The aqueous anticaking agent solution as described herein advantageously prevents clumping in the salt and allows for maintaining flowability for increased time relative to untreated salt. Because the present anticaking agent is water soluble, it is easy to apply to the salt to be treated, for example, by spraying. The aqueous anticaking agent solutions as described herein may be applied to sodium chloride salt, and has been found to be an effective anti-caking agent for prevention of clumping and caking.

The aqueous anticaking agent solution as described herein is particularly advantageous for use in the food industry, such as the dairy, cannery, processed meat and condiment segments. The aqueous anticaking agent solution as described herein is particularly advantageous for use in specialty salts, industrial applications, and deicing applications. The present aqueous anticaking agent solution is particularly useful for customers that use brining systems as an alternative to brining with untreated salt that is prone to caking or with anticaking agents that are expensive or less effective. The present aqueous anticaking agent is particularly useful for treating salt to be used for the electrolytic manufacture of chlorine and caustic, where nitrogen containing anti-caking agents create hazardous formation of nitrogen trichloride. The present aqueous anticaking agent is particularly useful for the treatment of rock salt for road and pavement deicing.

### BRIEF DESCRIPTION OF THE DRAWINGS

The accompanying drawings, which are incorporated in and constitute a part of this application, illustrate several aspects of the invention and together with a description of the embodiments serve to explain the principles of the invention. A brief description of the drawings is as follows:

FIG. 1 is a table showing species of citrate sources and their hydroxide equivalents.

FIG. 2 is a schematic process flow diagram of a manufacturing process for preparing aqueous iron citrate anti-caking solutions.

FIG. 3 is a schematic process flow diagram of an alternative manufacturing process for preparing aqueous iron citrate anti-caking solutions.

FIG. 4 is a graph showing the effect of pH of the intermediate iron citrate solution on anti-caking performance, in comparison to a TCP treated standard.

### DETAILED DESCRIPTION

The aspects of the present invention described below are not intended to be exhaustive or to limit the invention to the precise forms disclosed in the following detailed description. Rather a purpose of the aspects chosen and described is by way of illustration or example, so that the appreciation and understanding by others skilled in the art of the general principles and practices of the present invention can be facilitated.

As noted above, in an aspect, a method of making an aqueous anticaking agent solution comprises mixing a ferrous source, a citrate source, a hydroxide source and water together to form an intermediate aqueous mixture.

In an aspect, the anticaking agent in the aqueous anticaking agent solution is a functionally-active iron citrate composition that is a complexation product of iron(II) and iron(III) with citrate ionization ≥3.5 but ≤4.0. In an aspect, the anticaking agent in the aqueous anticaking agent solution comprises a complexation product of iron(II) and/or iron(III) with citrate ionization ≥3.5 and ≤4.0. In an aspect, the anticaking agent in the aqueous anticaking agent solution comprises a complexation product of iron(II) and/or iron(III) with citrate ionization ≥3.5 and ≤4.0. In an aspect, the anticaking agent in the aqueous anticaking agent solution comprises a complexation product of iron(II) and/or iron(III) with citrate ionization ≥3.0 and ≤4.0. In an aspect, the anticaking agent in the aqueous anticaking agent solution comprises a complexation product of iron(II) and/or iron(III) with citrate ionization ≥3.6 and ≤3.9. In an aspect, the anticaking agent in the aqueous anticaking agent solution comprises a complexation product of iron(II) and/or iron(III) with citrate ionization ≥3.7 and ≤4. In an aspect, the anticaking agent in the aqueous anticaking agent solution comprises a complexation product of iron(II) and/or iron(III) with citrate ionization ≥3.5 and ≤3.9. In an aspect, the anticaking agent in the aqueous anticaking agent solution consists of a complexation product of iron(II) and/or iron(III) with citrate ionization ≥3.5 and ≤4.0.

In an aspect, the anticaking agent has a formula of Naₓ₊₁FeC₆H₅₋ₓO₇, where x=0.5 to 1.0, with a molecular weight of 278.93-289.92 g/mol. The anti-caking agent may comprise two or more compounds according to the formula above, with each of the compounds having a different value for x. In an aspect, an aqueous solution of the anticaking agent comprises two or more compounds according to the formula above, with each of the compounds having a different value for x.

In principle, any Fe(II) salt can be used to prepare the present iron citrate complex, provided that that the counterion did not strongly compete with citrate for complexing the iron or otherwise interfere with the active iron citrate complex(es) formation. It has been found in an aspect that iron(II) salts selected from iron(II) sulfate, iron(II) chloride, iron(II) acetate and mixtures thereof are particularly useful as being easy to process and highly effective in providing the desired functionally active iron citrate complex.

It is noted that solutions prepared as described above from Fe(II) salts oxidize over time to Fe(III), and this has been found to provide an excellent anticaking solution. While not being bound by theory, it is believed that by the time the anticaking agent is applied to the salt, portions of the iron may be in the Fe(III) form. While in principle, one would expect that it should be possible to make the same complex(es) starting with an Fe(III) salt, in practice preparation of these complexed by an Fe(III) route has been found to be difficult. More specifically, it has been found that when the iron source is an Fe(III) salt, a significant amount of precipitation of materials from the aqueous solution is observed, particularly when the pH is adjusted to a pH of 5 or higher.

In contrast, when ferrous sources (i.e. Fe(II)) are used as a starting material to form the desired iron citrate complex, it has been found that the starting material components go into solution relatively easily and an iron complex that is highly effective as an anticaking agent is formed, even when the solution oxidizes to the ferric form upon standing over time.

In an aspect, the ferrous source is selected from the group consisting of ferrous chloride, ferrous sulfate; ferrous nitrate, ferrous acetate, ferrous hydroxide, and mixtures thereof.

For purposes of the present discussion, the total concentration of Fe present in intermediate aqueous mixtures or the aqueous anticaking agent solution is the iron present in all species in the solution.

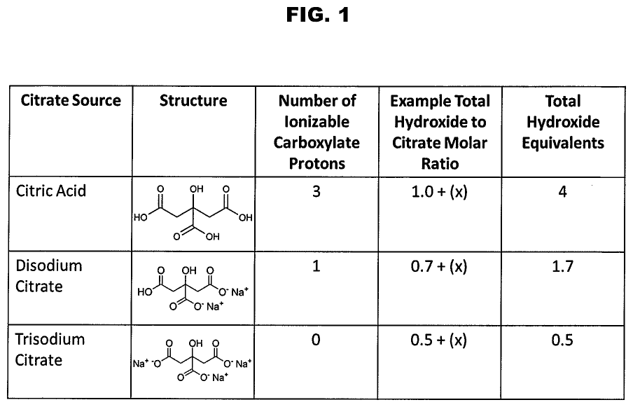

In an aspect, the citrate source is a mixture of citric acid with sufficient hydroxide source to form a salt at one or more of the three carboxylate moieties of the citrate with available anionic species in the solution. See FIG. 1, which shows various species of citrate sources, and examples of the corresponding hydroxide equivalents needed for preparation of example anti-caking intermediate solutions. In an aspect, the citrate source is a trianionic citrate and when a specific cation is identified for use, such as sodium, this species is referred to with the identified cation, as trisodium citrate. In an aspect, the citrate source is a dianionic citrate. In an aspect, the citrate source is a monoanionic citrate. In an aspect, the citrate source is citric acid.

In an aspect, the citrate source used in preparation of the present iron citrate complex source is selected from the group consisting of trisodium citrate, monosodium citrate, disodium citrate, monopotassium citrate, dipotassium citrate, tripotassium citrate, citric acid, monoammonium citrate, diammonium citrate, triammonium citrate, calcium citrate, magnesium citrate and mixtures thereof. In an aspect, the citrate source used in preparation of the present iron citrate complex source is selected from the group consisting of trisodium citrate, monosodium citrate, disodium citrate, monopotassium citrate, dipotassium citrate, tripotassium citrate, citric acid, monoammonium citrate, diammonium citrate, triammonium citrate and mixtures thereof. In an aspect, the citrate source is trisodium citrate. In an aspect, the citrate source comprises a hydrate, for example but not limited to trisodium citrate dihydrate.

In an aspect, the aqueous anticaking agent solution further comprises additional carboxylic acid species other than citrate, wherein no more than about 10% of the carboxylic acid species in the aqueous anticaking agent solution are carboxylic acid species other than citrate. In an aspect, no more than about 5% of the carboxylic acid species in the aqueous anticaking agent solution are carboxylic acid species other than citrate. In an aspect, the only hydroxypolycarboxylic acid species in the aqueous anticaking agent solution are citrate species.

In an aspect, the only carboxylic acid species in the aqueous anticaking agent solution are citrate species.

In an aspect, additional carboxylic acid species other than citrate comprises additional hydroxypolycarboxylic acid species other than citrate. In an aspect, the additional hydroxypolycarboxylic acid species is selected from compounds having from 3 to 10 carbon atoms, one or more hydroxy groups, and two or more carboxylic acid groups, or mixtures of such acids. In an aspect, the hydroxypolycarboxylic acids are selected from, tartaric acid species, gluconic acid species, saccharic acid species, mucic acid species, and mixtures thereof.

In an aspect, the additional carboxylic acid species other than citrate is selected from compounds having from 1 to 10 carbon atoms, 0 or more hydroxy groups, and one or more carboxylic acid groups, and mixtures of such acids. In an aspect, the carboxylic acid species are selected from formic acid, acetic acid, propionic acid, acrylic acid, lactic acid, pyruvic acid, butyric acid, succinic acid, fumaric acid, malic acid, itaconic acid, and mixtures of such acids.

In an aspect, the hydroxy source used in preparation of the present iron citrate complex source is selected from the group consisting of consisting of sodium hydroxide, potassium hydroxide, ammonium hydroxide and mixtures thereof.

In an aspect, the ferrous source and the citrate are present in a Fe to citrate molar ratio of from 0.5 to 1.5. In an aspect, the ferrous source and the citrate source are present in the intermediate aqueous mixture in a Fe to citrate molar ratio of from 0.8 to 1.3. In an aspect, the ferrous source and the citrate source are present in the intermediate aqueous mixture in a Fe to citrate molar ratio of from 0.9 to 1.1.

In an aspect wherein the aqueous anticaking agent solution further comprises additional hydroxypolycarboxylic acid species other than citrate, the ferrous source and the hydroxypolycarboxylic acid species (including citrate) are present in a Fe to hydroxypolycarboxylic acid species molar ratio of from 0.5 to 1.5. In an aspect, the ferrous source and the hydroxypolycarboxylic acid species are present in the intermediate aqueous mixture in a Fe to hydroxypolycarboxylic acid species molar ratio of from 0.8 to 1.3. In an aspect, the ferrous source and the citrate source are present in the intermediate aqueous mixture in a Fe to hydroxypolycarboxylic acid species molar ratio of from 0.9 to 1.1.

In an aspect, the hydroxide source and the citrate source are present in an amount to give a total hydroxide to citrate molar ratio within the range from (0.1+x) to (1.0+x), where x=the number of ionizable protons associated with the carboxylate sites on the citrate source. In an aspect, the hydroxide source and the citrate source are present in an amount to give a total hydroxide to citrate molar ratio within the range from (0.5+x) to (1.0+x), where x=the number of ionizable protons associated with the carboxylate sites on the citrate source. For clarity regarding calculation of this ratio, it is noted that citric acid is a hydroxypolycarboxylic acid comprising three carboxylate moieties and one hydroxyl moiety. As illustrated in FIG. 1, the number of ionizable carboxylate protons on any given citrate source may be from 3 to 0, which is determined by the species present and the pH of the solution. Thus, for example, when the citrate source is trisodium citrate, the number of ionizable protons associated with the carboxylate sites on the citrate source is 0, and the targeted total hydroxide to citrate molar ratio is (0.5+0) to (1.0+0), which is a molar ratio of from 0.5 to 1.0 additional equivalents of hydroxide. Likewise, for example, when the citrate source is disodium citrate, the number of ionizable protons associated with the carboxylate sites on the citrate source is 1, and the targeted total hydroxide to citrate molar ratio is (0.5+1) to (1.0+1), which is a molar ratio of from 1.5 to 2.0 additional equivalents of hydroxide. It will be understood that where the citrate source is a mixture of species having different numbers of ionizable carboxylate protons, the total hydroxide required can be calculated from the molar ratio/equivalents of the mixture of citrate and other species.

It has been found that anti-caking effectiveness of the iron citrate solutions decreases with decreasing equivalents of citrate, and that higher equivalents do not provide a statistically significant increase in effectiveness. It has additionally been found that using pre-prepared citrate salts, such as trianionic citrate, is advantageous as a convenient, controlled source of citrate ion, as compared to salts prepared in situ.

In an aspect wherein the aqueous anticaking agent solution further comprises additional carboxylic acid species other than citrate, the hydroxide source and the carboxylic acid species (including citrate) are present in an amount to give a total hydroxide to carboxylic acid species molar ratio of from (0.5+x) to (1.0+x), where x=the number of ionizable protons associated with the carboxylate sites on the carboxylic acid species. In this case, the hydroxide source is present in an amount to give a total hydroxide to carboxylic acid species molar ratio of from (0.5+x) to (1.0+x), where x=the number of ionizable protons associated with the carboxylate sites on the carboxylic acid species.

In an aspect, the pH of the aqueous anticaking agent solution is adjusted by addition of a hydroxide source. In an aspect the hydroxide source is selected from the group consisting of consisting of sodium hydroxide, potassium hydroxide, ammonium hydroxide and mixtures thereof.

In an aspect, the amount of hydroxide source to be used is determined by mixing the ferrous source, the citrate source, the hydroxide source and water together to form an intermediate aqueous mixture, with addition of sufficient hydroxide source in an amount such that the intermediate aqueous mixture has a pH at the time of mixing of at least 5. In an aspect, hydroxide source is present in an amount such that the intermediate aqueous mixture has a pH at the time of mixing of from 5 to 10. In an aspect, hydroxide source is present in an amount such that the intermediate aqueous mixture has a pH at the time of mixing of from 5 to 9. In an aspect, hydroxide source is present in an amount such that the intermediate aqueous mixture has a pH at the time of mixing of from 5 to 7.5. In an aspect, hydroxide source is present in an amount such that the intermediate aqueous mixture has a pH at the time of mixing of from 6 to 10. In an aspect, hydroxide source is present in an amount such that the intermediate aqueous mixture has a pH at the time of mixing of from 6 to 9. In an aspect, hydroxide source is present in an amount such that the intermediate aqueous mixture has a pH at the time of mixing of from 6 to 7.5.

The ferrous source, the citrate source and hydroxide source may be mixed in any manner appropriate for preparation of the aqueous anticaking agent solution.

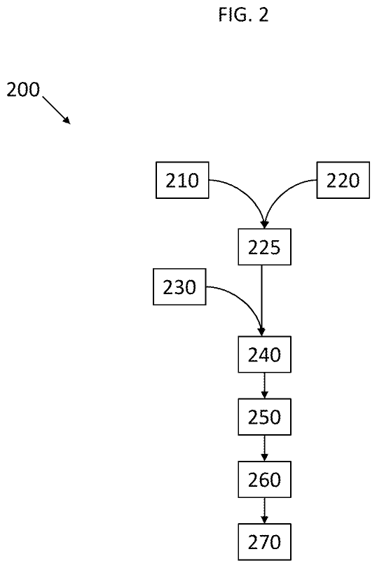

A schematic process flow diagram of a manufacturing process for preparing aqueous iron citrate anti-caking solutions is shown in FIG. 2. In process 200, a hydroxide source 210 and a citrate source 220 are combined in water with mixing and stirring to form a solution 225. A ferrous source 230 is added to the hydroxide/citrate solution 225, optionally in solid form. The components are stirred to form an intermediate aqueous mixture 240. The components are allowed to be present for a time sufficient to form at least one soluble iron citrate complex to provide an aqueous anticaking agent solution 250. Optional post iron citrate complex formation processing steps 260 may be carried out to remove precipitated species, thereby providing a final aqueous anticaking agent solution 270.

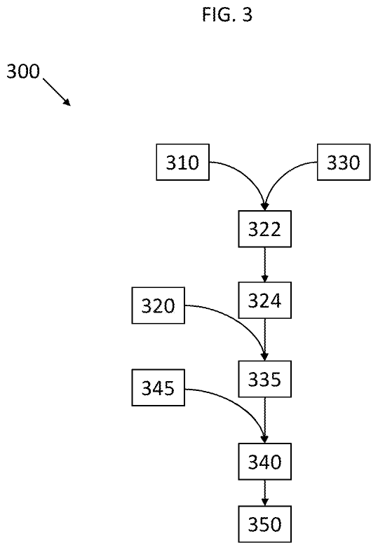

A schematic process flow diagram of an alternative manufacturing process for preparing aqueous iron citrate anti-caking solutions is shown in FIG. 3. In process 300, a hydroxide source 310 and a ferrous source 330 are combined in water with mixing and stirring to form a solid ferrous hydroxide 322. The solid ferrous hydroxide is isolated and resuspended in water to form a ferrous hydroxide suspension 324. A citrate source 320 is added to the ferrous hydroxide suspension, and the components are stirred to form a solution 335 to which a second hydroxide source 345 is added to form an intermediate aqueous mixture 340. The components are allowed to be present for a time sufficient to form at least one soluble iron citrate complex to provide an aqueous anticaking agent solution 350.

In an aspect, the citrate source and the ferrous source are mixed first, followed by addition of the hydroxide source to form the intermediate aqueous mixture.

In an aspect, it is desirable to prepare the aqueous anticaking agent solution to have a very high concentration with a minimum amount of water. This provides unique challenges. It has been found in an aspect to be advantageous to carry out the mixing process without dissolving individual components separately before being combined and mixed. In an aspect, effective, concentrated aqueous anticaking agent solutions may be prepared by first combining the citrate source and the hydroxide source components in the amount of water needed for the desired solution concentration. The citrate source and hydroxide source components are stirred vigorously and allowed to mix for several minutes, although they do not fully dissolve at higher concentrations, before the iron salt is added as a solid. The suspension is allowed to mix vigorously and darkens in color as the solids slowly dissolve. Once the solids are completely dissolved, the resulting iron citrate solution is effective as an anticaking agent in salt.

In an aspect, the aqueous anticaking agent solution has an iron citrate concentration calculated as ppm Fe of at least 24,000 ppm Fe. In an aspect, the aqueous anticaking agent solution has an iron citrate concentration calculated as ppm Fe of at least 40,000 ppm Fe. In an aspect, the aqueous anticaking agent solution has an iron citrate concentration calculated as ppm Fe of at least 50,000 ppm Fe. In an aspect, the aqueous anticaking agent solution has an iron citrate concentration calculated as ppm Fe of at least 60,000 ppm Fe. In an aspect, the aqueous anticaking agent solution has an iron citrate concentration calculated as ppm Fe of at least 70,000 ppm Fe. In an aspect, the aqueous anticaking agent solution has an iron citrate concentration calculated as ppm Fe of at least 75,000 ppm Fe. In an aspect, the aqueous anticaking agent solution has an iron citrate concentration calculated as ppm Fe of at least 80,000 ppm Fe. In an aspect, the aqueous anticaking agent solution has an iron citrate concentration calculated as ppm Fe of at least 90,000 ppm Fe. In an aspect, the aqueous anticaking agent solution has an iron citrate concentration calculated as ppm Fe of at least 100,000 ppm Fe.

In an aspect, the aqueous anticaking agent solution is substantially free of nitrogen. In an aspect, the aqueous anticaking agent solution is substantially free of heavy metals. In an aspect, no more than about 10% of the hydroxypolycarboxylic acid anions in the aqueous anticaking agent solution are hydroxypolycarboxylic acid anions other than citrate. In an aspect, no more than about 5% of the hydroxypolycarboxylic acid anions in the aqueous anticaking agent solution are hydroxypolycarboxylic acid anions other than citrate. In an aspect, the aqueous anticaking agent solution is substantially free of hydroxypolycarboxylic acid anions other than citrate. In an aspect, the aqueous anticaking agent solution is substantially free of meso-tartrate anions. In an aspect, the aqueous anticaking agent solution(s) and/or anticaking agent(s) described herein do not contain any detectable meso-tartrate anions or meso-tartrate compounds.

In an aspect, no more than about 10% of the carboxylic acid anions in the aqueous anticaking agent solution are carboxylic acid anions other than citrate. In an aspect, no more than about 5% of the carboxylic acid anions in the aqueous anticaking agent solution are carboxylic acid anions other than citrate. In an aspect, the aqueous anticaking agent solution is substantially free of carboxylic acid anions other than citrate.

It has been discovered that preparing highly concentrated, low moisture content iron citrate solutions is challenging due to stability problems. Specifically, it was found that conventionally prepared concentrated iron citrate solutions tend to form precipitates on standing.

It was discovered that precipitation of salts is significantly reduced by mixing the ferrous source, citrate source, and hydroxide source in the ratios described herein and allowing the resulting aqueous ionic solution to be present for a time sufficient to form at least one soluble iron citrate complex, yielding an aqueous anticaking agent solution comprising a soluble iron citrate complex or complexes. While not being bound by theory, it is believed that a portion of the ferrous ions oxidizes to form ferric ions, and the resulting iron citrate complex comprises a mixture of iron in various oxidation states that forms an iron citrate complex that exhibits superior stability properties.

For purposes of the present discussion an aqueous anticaking agent solution is considered to be stable if after resting at 23° C. for the specified time, the aqueous anticaking agent solution comprises no more than 5% precipitate by mass of the solution. In an aspect, the aqueous anticaking agent solution is stable at 23° C. for at least 1 hour. In an aspect, the aqueous anticaking agent solution is stable at 23° C. for at least 8 hours. In an aspect, the aqueous anticaking agent solution is stable at 23° C. for at least 12 hours. In an aspect, the aqueous anticaking agent solution is stable at 23° C. for at least 24 hours. In an aspect, the aqueous anticaking agent solution is stable at 23° C. for at least 5 days. In an aspect, the aqueous anticaking agent solution is stable at 23° C. for at least 14 days. In an aspect, the aqueous anticaking agent solution is stable at 23° C. for at least 21 days. In an aspect, the aqueous anticaking agent solution is stable at 23° C. for at least 28 days.

In an aspect, the aqueous anticaking agent solution does not contain precipitates that can be observed by visual inspection without magnification. In an aspect, the method(s) described herein may further comprise a filtration step to remove precipitates or particulates. In an aspect, the aqueous anticaking agent solution(s) described herein are substantially free of precipitates or particulates.

In an aspect, it was discovered that the stability of the aqueous anticaking agent solution can be enhanced by cooling the prepared aqueous anticaking agent solution to initiate and/or promote precipitation of less stable species present in the solution, and filtering the cold solution to prepare solutions that are more stable to further precipitation. Advantageously, it has been discovered that this added filtration step removes unstable species and consequently increases the relative concentration of stable iron citrate complexes in the resulting aqueous anticaking agent solution, thereby providing even more stable, highly concentrated aqueous anticaking agent solutions.

It has been found that by using the techniques described herein, it is possible to prepare stable aqueous anticaking agent solutions having iron citrate at very high concentrations, including concentrations as high as at least 60,000 ppm Fe; or concentrations as high as at least 70,000 ppm Fe; or concentrations as high as at least 75,000 ppm Fe; or concentrations as high as at least 80,000 ppm Fe; or concentrations as high as at least 90,000 ppm Fe; or concentrations as high as at least 100,000 ppm Fe.

Stability of the iron citrate solutions upon transport, pumping, and storage is obviously another concern. References to “stable” or “stability” and the like are intended to mean “stable to precipitation” for the purposes of this disclosure unless specifically indicated otherwise herein.

In an aspect, it has been found that stability of the present aqueous anticaking agent solution may be enhanced by adding an oxidizing agent to the aqueous mixture of ferrous salt, citrate salt and hydroxide salt in aqueous solution, oxidizing the ferrous ion to the ferric (if, e.g., formation of the “yellow precipitate” is due to an Fe(II) rather than an Fe(III) complex. In an aspect, the oxidizing agent is hypochlorite.

While not being bound by theory, it is believed that the iron citrate complex of the present aqueous anticaking agent solution functions as a crystal habit modifier, and is effective as an anti-caking agent at very low (ppm) levels. In an aspect, the present aqueous anticaking agent solution has been found to be effective when applied to the salt to be treated in the form of a concentrated solution in water. In an aspect, the present aqueous anticaking agent solution is sprayed onto the salt and the treated salt is briefly mixed for homogeneity just before packaging of the treated salt for storage, and/or transport.

It has been found that the total moisture level in a finished salt product is important. If too much moisture is present, the salt to be treated will be made wet, decreasing the salt's flowability and increasing the tendency of the salt to cake. It was therefore discovered that the present solutions may advantageously be formulated in high concentrations to minimize the amount of water added with the iron citrate solution. In an aspect salt treated with the present aqueous anticaking agent solution has a moisture content of about 0.02% or lower. Theoretical iron citrate solution concentrations, calculated as ppm Fe, and their respective additive levels and moisture contribution to the finished product are provided in the following Table 1.

TABLE 1

| | | g aqueous | | | | | |
|---|---|---|---|---|---|---|---|
| | | anticaking agent | | | % Added | | |
| Solution | % | solution/Kg Salt | | | Moisture | | |
| Concen- | Moisture | 10 | 20 | 30 | 10 | 20 | 30 |
| tration | in | ppm | ppm | ppm | ppm | ppm | ppm |
| (ppm Fe) | solution | Fe | Fe | Fe | Fe | Fe | Fe |
| 24845 | 85% | 0.40 | 0.80 | 1.21 | 0.034 | 0.069 | 0.103 |
| 44309 | 67% | 0.23 | 0.45 | 0.68 | 0.015 | 0.030 | 0.045 |
| 51530 | 61% | 0.19 | 0.39 | 0.58 | 0.012 | 0.024 | 0.036 |
| 54489 | 59% | 0.18 | 0.37 | 0.55 | 0.011 | 0.022 | 0.032 |
| 56942 | 57% | 0.18 | 0.35 | 0.53 | 0.010 | 0.020 | 0.030 |
| 59852 | 56% | 0.17 | 0.33 | 0.50 | 0.009 | 0.019 | 0.028 |
| 65643 | 51% | 0.15 | 0.30 | 0.46 | 0.008 | 0.016 | 0.023 |
| 70001 | 48% | 0.14 | 0.29 | 0.43 | 0.007 | 0.014 | 0.021 |
| 79369 | 41% | 0.13 | 0.25 | 0.38 | 0.005 | 0.010 | 0.016 |

In an aspect, salt treated with the aqueous anticaking agent solution described herein exhibits a Relative Caking Value when applied at an application rate of 10 mg Fe per kg to untreated salt that is statistically the same or less than a sample treated by a TCP anti-caking agent applied to the untreated salt at an application rate of 1% TCP, as evaluated under the Standard Anti-Caking Test described below. It is noted that achieving a Relative Caking Value that is statistically the same or less than a TCP anti-caking agent by the present aqueous anticaking agent solution is both surprising and beneficial. TCP is considered a highly effective anticaking agent, and to achieve this level of Relative Caking Value by a product that meets organic product labeling requirements and can obtain GRAS approval provides unexpected benefit.

Salt may be treated by providing a dry salt composition comprising sodium chloride. In an aspect, the salt is NaCl.

In an aspect, the aqueous anticaking agent solution as described herein is applied to a salt composition that has been pretreated to reduce surface moisture content of the salt. Such low moisture content salts may find particular advantage in certain applications, such as in uses in the food industry. In an aspect, the untreated salt composition has a surface moisture content of no more than 0.03%. In an aspect, application of high concentration versions of the present aqueous anticaking agent solution to such pretreated salts advantageously provide treated salt products having a low moisture content, which in an aspect does not require post application processing steps to facilitate handling or to achieve other advantageous properties.

In an aspect, the aqueous anticaking agent solution as described herein is applied to the dry salt composition in an amount sufficient to provide a treated salt product having a surface moisture content of 0.04% or lower. In an aspect, the aqueous anticaking agent solution is applied in an amount sufficient to provide a treated salt product having a surface moisture content of 0.03% or lower. In an aspect, the aqueous anticaking agent solution is applied in an amount sufficient to provide a treated salt product having a surface moisture content of 0.02% or lower. In an aspect, the aqueous anticaking agent solution is applied in an amount sufficient to provide a treated salt product having a surface moisture content of 0.018% or lower. In an aspect, the aqueous anticaking agent solution is applied in an amount sufficient to provide a treated salt product having a surface moisture content of 0.015% or lower.

In an aspect, the aqueous anticaking agent solution is applied in an amount in an amount effective to reduce caking of the salt. In an aspect, the aqueous anticaking agent solution is applied at an application rate of from 0.5 mg Fe per kg salt to 200 mg Fe per kg salt. In an aspect, the aqueous anticaking agent solution is applied at an application rate of from 2 mg Fe per kg salt to 200 mg Fe per kg salt. In an aspect, the aqueous anticaking agent solution is applied at an application rate of from 5 mg Fe per kg salt to 150 mg Fe per kg salt. In an aspect, the aqueous anticaking agent solution is applied at an application rate of from 5 mg Fe per kg salt to 100 mg Fe per kg salt. In an aspect, the aqueous anticaking agent solution is applied at an application rate of from 5 mg Fe per kg salt to 50 mg Fe per kg salt.

### Standard Anti-Caking Test

Anti-caking effectiveness was measured via a method that subjected salt samples to aggressive caking conditions and compared the relative percentages of clumping in the sample to a performance benchmark. Samples were subjected to conditions alternating above and below the critical relative humidity of sodium chloride to induce caking, followed by weighing the proportion of sample retained on an appropriately sized screen (dependent on particle size of the salt being analyzed). Samples were run in 4 replicates per test, and compared to Alberger® Fine Flake Prepared with 1% TCP (as described in Safety Data Sheet 922265, Version #: 01, Issue date: 19 Nov. 2014) as a performance benchmark (the 1% TCP Standard”). This product was selected as the benchmark because Alberger® Fine Flake Prepared is a commercial product that has been found from experience to be acceptably resistant to caking for typical customer applications.

Samples are assigned as having acceptable performance if they exhibit a Relative Caking Value less than or not different with statistical significance to the Relative Caking Value of the 1% TCP Standard. Statistical comparison of means from the data in each separate test was carried out using a Tukey-Kramer Honest Significant Difference approach. Within a given test, formulas not connected by the same letter are statistically different at α=0.05.

### EXAMPLES

### Example 1—Preparation of Aqueous Anticaking Agent Solution Having pH=5.7

An iron citrate-containing starting material solution was prepared by combining trisodium citrate dihydrate (Na₃C₆H₅O₇, 500 g, 1.7 mol) and sodium hydroxide (NaOH, 57 g, 1.43 mol) in water (H₂O, 550 g). To the stirring suspension was added ferrous sulfate heptahydrate (FeSO₄·7H₂O, 473 g, 1.7 mol) and the mixture was stirred vigorously (˜30 min) until all of the solids dissolved, giving a dark green solution with pH=5.71. The thus prepared intermediate aqueous mixture was then filtered to remove any incidental precipitate present to provide an aqueous anticaking agent solution.

### Example 2—Preparation of Aqueous Anticaking Agent Solution Having pH=6.5

An iron citate-containing aqueous anticaking agent solution was prepared by combining trisodium citrate dihydrate (Na₃C₆H₅O₇, 50 g, 170 mmol) and sodium hydroxide (NaOH, 6.8 g, 170 mmol) in water (H₂O, 68.6 g). To the stirring suspension was added ferrous chloride tetrahydrate (FeCl₂·4H₂O, 33.8 g, 170 mmol), and the mixture was stirred vigorously until all of the solids dissolved to provide an aqueous anticaking agent solution.

The thus prepared aqueous anticaking agent solution was applied to salt at a rate of 0.17 g/Kg salt, to give an additive level of 10 ppm (Fe basis).

### Example 3—Preparation of Aqueous Anticaking Agent Solution Having pH=5.3

In a multi-step preparation of an iron citate-containing aqueous anticaking agent solution, sodium hydroxide (NaOH, 12.8 g, 230 mmol) was added to a solution of ferrous sulfate heptahydrate (FeSO₄·7H₂O, 31.8 g, 114 mmol) in water (300 g). The resulting ferrous hydroxide (Fe(OH)₂) blue/green precipitate was isolated by filtration and washed with water before being resuspended in water (H₂O, 80 g). Citric acid (C₆H₈O₇, 24 g, 114 mmol) was slowly added to the suspension in portions, resulting in an exothermic reaction where the suspension became a homogenous solution upon the addition of the citric acid. Additional sodium hydroxide (NaOH, 12.8 g, 230 mmol) was added dropwise to the solution, resulting in a dark green homogenous iron citate-containing aqueous anticaking agent solution with a pH=5.3.

### Comparative Example 4—Preparation of Aqueous Anticaking Agent Solution Having pH=4.52

An iron citate-containing solution was prepared by suspending trisodium citrate dihydrate (Na₃C₆H₅O₇, 2.5 g, 8.5 mmol) in water (H₂O, 68.6 g), before adding ferrous sulfate heptahydrate (FeSO₄·7H₂O, 2.4 g, 8.6 mmol). The mixture was stirred vigorously until all of the solids dissolved to provide a dark green aqueous solution with a pH=4.52.

### Comparative Example 5—Preparation of Aqueous Anticaking Agent Solution Having pH=0.16

An iron and citrate containing solution was prepared by combining citric acid (C₆H₈O₇, 1.8 g, 8.6 mmol), ferrous sulfate heptahydrate (FeSO₄·7H₂O, 2.4 g, 8.6 mmol) and sulfuric acid (H₂SO₄, 98%, 1.4 g) in water (H₂O, 6.8 g). The mixture was stirred until all of the solids dissolved, giving a homogenous pale green solution with pH=0.16.

### Example 6—Comparison of Treated Salt

Salt samples were prepared for evaluation using the Standard Anti-Caking Test using the described TCP standard and the Aqueous Anticaking Agent Solutions of Example 1 and of Comparative Examples 4 and 5.

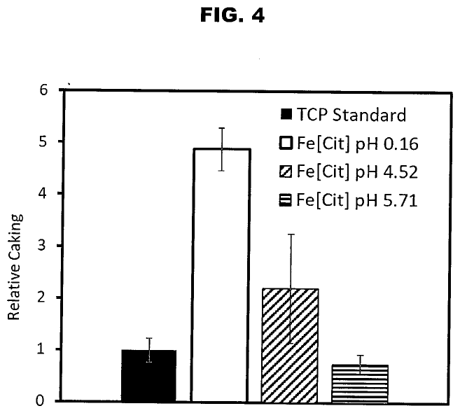

The Relative Caking Values for each of these treatments is shown in FIG. 4. The Aqueous Anticaking Agent Solutions of Comparative Examples 4 and 5 exhibit Relative Caking Values that well exceed the Relative Caking Value of the TCP standard, and therefore were unacceptable, while the Aqueous Anticaking Agent Solution of Example 1 exhibits a Relative Caking Value that is lower than the Relative Caking Value of the TCP standard, and therefore was acceptable. Statistical analysis information is provided in Table 2:

TABLE 2
Statistical Analysis

| Sample | Statistical Grouping p = 0.05 |
|---|---|
| TCP Standard | C |
| Comparative Example 5 | A |
| Fe[Cit] pH 0.16 | |
| Comparative Example 4 | B |
| Fe[Cit] pH 4.52 | |
| Example 1 | C |
| Fe[Cit] pH 5.71 | |

As used herein, the terms “about” or “approximately” mean within an acceptable range for the particular parameter specified as determined by one of ordinary skill in the art, which will depend in part on how the value is measured or determined, e.g., the limitations of the sample preparation and measurement system. Examples of such limitations include preparing the sample in a wet versus a dry environment, different instruments, variations in sample height, and differing requirements in signal-to-noise ratios. For example, “about” can mean greater or lesser than the value or range of values stated by 1/10 of the stated values, but is not intended to limit any value or range of values to only this broader definition. For instance, a concentration value of about 30% means a concentration between 27% and 33%. Each value or range of values preceded by the term “about” is also intended to encompass the embodiment of the stated absolute value or range of values. Alternatively, particularly with respect to biological systems or processes, the term can mean within an order of magnitude, preferably within 5-fold, and more preferably within 2-fold, of a value.

### Additional Examples

The following additional examples are non-limiting examples of the invention.

Example 1. A method of making an aqueous anticaking agent solution comprising mixing a ferrous source, a citrate source, a hydroxide source and water together to form an intermediate aqueous mixture, wherein the ferrous source and the citrate source are present in a Fe to citrate molar ratio of from 0.5 to 1.5, and the hydroxide source is present in an amount to give a total hydroxide to citrate molar ratio of from (0.5+x) to (1.0+x), from (0.4+x) to (1.0+x), from (0.3+x) to (1.0+x), from (0.2+x) to (1.0+x), from (0.1+x) to (1.0+x), where x=the number of ionizable protons associated with the carboxylate sites on the citrate source; allowing the ferrous source, citrate source, and hydroxide source to be present in the intermediate aqueous mixture for a time sufficient to form at least one soluble iron citrate complex to provide an aqueous anticaking agent solution.

Example 2. A method of making an aqueous anticaking agent solution comprising mixing a ferrous source, a citrate source, a hydroxide source and water together to form an intermediate aqueous mixture, wherein the ferrous source and the citrate source are present in a Fe to citrate molar ratio of from 0.5 to 1.5, and the hydroxide source is present in an amount such that the intermediate aqueous mixture has a pH at the time of mixing of at least 5; allowing the ferrous source, citrate source, and hydroxide source to be present in the intermediate aqueous mixture for a time sufficient to form at least one soluble iron citrate complex to provide an aqueous anticaking agent solution.

Example 3. The method of examples 1 or 2, wherein the ferrous source and the citrate source are present in the intermediate aqueous mixture in a Fe to citrate molar ratio of from 0.8 to 1.3, or the ferrous source and the citrate source are present in the intermediate aqueous mixture in a Fe to citrate molar ratio of from 0.9 to 1.1.

Example 4. The method of any one of examples 1-3, wherein the intermediate aqueous mixture has a pH at the time of mixing of from 5 to 10, or wherein the intermediate aqueous mixture has a pH at the time of mixing of from 5 to 9, or wherein the intermediate aqueous mixture has a pH at the time of mixing of from 5 to 7.5, or wherein the intermediate aqueous mixture has a pH at the time of mixing of 6 to 10, or wherein the intermediate aqueous mixture has a pH at the time of mixing of from 6 to 9, or wherein the intermediate aqueous mixture has a pH at the time of mixing of from 6 to 7.5.

Example 5. The method of any one of examples 1-4, wherein the citrate source and the hydroxide source are mixed first, followed by addition of the ferrous source to form the intermediate aqueous mixture.

Example 6. The method of any one of examples 1-4, wherein the citrate source and the ferrous source are mixed first, followed by addition of the hydroxide source to form the intermediate aqueous mixture.

Example 7. The method of any one of examples 1-4, wherein the hydroxide source and the ferrous source are mixed first, followed by addition of the citrate source to form the intermediate aqueous mixture.

Example 8. The method of any one of examples 1-7, wherein the iron source is added as a solid.

Example 9. The method of any one of examples 1-8, wherein the ferrous source is selected from the group consisting of ferrous chloride, ferrous sulfate; ferrous nitrate, ferrous acetate, ferrous hydroxide, and mixtures thereof.

Example 10. The method of any one of examples 1-9, wherein the citrate source is selected from the group consisting of trisodium citrate, monosodium citrate, disodium citrate, monopotassium citrate, dipotassium citrate, tripotassium citrate, citric acid, monoammonium citrate, diammonium citrate, triammonium citrate, calcium citrate, magnesium citrate and mixtures thereof.

Example 11. The method of any one of examples 1-9, wherein the citrate source is selected from the group consisting of trisodium citrate, monosodium citrate, disodium citrate, monopotassium citrate, dipotassium citrate, tripotassium citrate, citric acid, monoammonium citrate, diammonium citrate, triammonium citrate, and mixtures thereof.

Example 12. The method of any one of examples 1-11, wherein the hydroxide source is selected from the group consisting of sodium hydroxide, potassium hydroxide, ammonium hydroxide and mixtures thereof.

Example 13. The method of any one of examples 1-12, further comprising conducting post iron citrate complex formation processing steps to remove precipitated species.

Example 14. The method of any one of examples 1-13, wherein the post iron citrate complex formation processing step to remove precipitated species comprises cooling the aqueous anticaking agent solution to a temperature of 10° C. or less, removing any precipitate that has formed, and allowing the aqueous anticaking agent solution to return to room temperature.

Example 15. The method of any one of examples 1-14, wherein the solution is heated while mixing the ferrous source, the citrate source, the hydroxide source and water together; or wherein the solution is heated to a temperature of from about 50° C. to about 90° C. while mixing the ferrous source, the citrate source, the hydroxide source and water together; or wherein the solution is heated to a temperature of from about 60° C. to about 80° C. while mixing the ferrous source, the citrate source, the hydroxide source and water together.

Example 16. The method of any one of examples 1-15, wherein the total concentration of Fe present in the aqueous anticaking agent solution is at least 24,000 ppm Fe; or wherein the total concentration of Fe present in the aqueous anticaking agent solution is at least 50,000 ppm Fe; or wherein the total concentration of Fe present in the aqueous anticaking agent solution is at least 60,000 ppm Fe; or concentrations as high as at least 70,000 ppm Fe; or wherein the total concentration of Fe present in the aqueous anticaking agent solution is at least 75,000 ppm Fe; or concentrations as high as at least 80,000 ppm Fe; or concentrations as high as at least 90,000 ppm Fe; or concentrations as high as at least 100,000 ppm Fe.

Example 17. The method of any one of examples 1-16, wherein the aqueous anticaking agent solution is stable to precipitation at 23° C. for at least 1 hour; or wherein the aqueous anticaking agent solution is stable at 23° C. for at least 8 hours; or wherein the aqueous anticaking agent solution is stable at 23° C. for at least 12 hours; or wherein the aqueous anticaking agent solution is stable at 23° C. for at least 24 hours; or wherein the aqueous anticaking agent solution is stable at 23° C. for at least 5 days; or wherein the aqueous anticaking agent solution is stable at 23° C. for at least 14 days; or wherein the aqueous anticaking agent solution is stable at 23° C. for at least 21 days; or wherein the aqueous anticaking agent solution is stable at 23° C. for at least 28 days.

Example 18. The method of any one of examples 1-17, wherein the aqueous anticaking agent solution has a water content in solution of from 30% to 85%; or wherein the aqueous anticaking agent solution has a water content in solution of from 30% to 70%; or wherein the aqueous anticaking agent solution has a water content in solution of from 30% to 60%; or wherein the aqueous anticaking agent solution has a water content in solution of from 30% to 50%; or wherein the aqueous anticaking agent solution has a water content in solution of from 40% to 85%; or wherein the aqueous anticaking agent solution has a water content in solution of from 40% to 70%; or wherein the aqueous anticaking agent solution has a water content in solution of from 40% to 60%; or wherein the aqueous anticaking agent solution has a water content in solution of from 40% to 50%.

Example 19. The method of any one of examples 1-18, wherein the aqueous anticaking agent solution further comprises additional hydroxypolycarboxylic acid species other than citrate, wherein no more than about 10% of the hydroxypolycarboxylic acid species in the aqueous anticaking agent solution are hydroxypolycarboxylic acid species other than citrate; or wherein no more than about 5% of the hydroxypolycarboxylic acid species in the aqueous anticaking agent solution are hydroxypolycarboxylic acid species other than citrate.

Example 20. The method of any one of examples 1-18, wherein the aqueous anticaking agent solution further comprises additional carboxylic acid species other than citrate, wherein no more than about 10% of the carboxylic acid species in the aqueous anticaking agent solution are carboxylic acid species other than citrate; or wherein no more than about 5% of the carboxylic acid species in the aqueous anticaking agent solution are carboxylic acid species other than citrate.

Example 21. The method of any one of examples 1-18, wherein the only hydroxypolycarboxylic acid species in the aqueous anticaking agent solution are citrate species.

Example 22. A method of making an aqueous anticaking agent solution comprising: Adding a hydroxide source to a solution of a ferrous source in water; collecting any resulting ferrous hydroxide precipitate; Forming a suspension of the ferrous hydroxide precipitate in water; Adding a citrate source and a second hydroxide source to the suspension and forming an iron citrate complex solution such that the ferrous source and the citrate source are present in a Fe to citrate molar ratio of from 0.5 to 1.5, and the second hydroxide source is present in an amount to give a total hydroxide (including the hydroxide content from the ferrous hydroxide) to citrate molar ratio of from (0.5+x) to (1.0+x), where x=the number of ionizable protons associated with the carboxylate sites on the citrate source to form an intermediate aqueous mixture; and allowing the ferrous salt, the citrate source, and the second hydroxide source to be present in the intermediate aqueous mixture for a time sufficient to form at least one soluble iron citrate complex to provide an aqueous anticaking agent solution; wherein the total concentration of Fe present in the aqueous anticaking agent solution is at least 24,000 ppm Fe; or wherein the total concentration of Fe present in the aqueous anticaking agent solution is at least 50,000 ppm Fe; or wherein the total concentration of Fe present in the aqueous anticaking agent solution is at least 60,000 ppm Fe; or wherein the total concentration of Fe present in the aqueous anticaking agent solution is at least 75,000 ppm Fe; or concentrations as high as at least 80,000 ppm Fe; or concentrations as high as at least 90,000 ppm Fe; or concentrations as high as at least 100,000 ppm Fe.

Example 23. An aqueous anticaking agent solution prepared by the method of any one of examples 1-22.

Example 24. An aqueous anticaking agent solution comprising at least one iron citrate complex, wherein the aqueous anticaking agent solution has a Fe to citrate molar ratio of from 0.5 to 1, a pH of at least 5, and the total concentration of Fe present in the aqueous anticaking agent solution is at least 24,000 ppm Fe.

Example 25. The aqueous anticaking agent solution of examples 23 or 24, wherein the total concentration of Fe present in the aqueous anticaking agent solution is at least 50,000 ppm Fe; or wherein the total concentration of Fe present in the aqueous anticaking agent solution is at least 60,000 ppm Fe; or wherein the total concentration of Fe present in the aqueous anticaking agent solution is at least 75,000 ppm Fe; or concentrations as high as at least 80,000 ppm Fe; or concentrations as high as at least 90,000 ppm Fe; or concentrations as high as at least 100,000 ppm Fe.

Example 26. The aqueous anticaking agent solution of any one of examples 23-25, wherein the aqueous anticaking agent solution has a water content in solution of from 30% to 85%; or wherein the aqueous anticaking agent solution has a water content in solution of from 30% to 70%; or wherein the aqueous anticaking agent solution has a water content in solution of from 30% to 60%; or wherein the aqueous anticaking agent solution has a water content in solution of from 30% to 50%; or wherein the aqueous anticaking agent solution has a water content in solution of from 40% to 85%; or wherein the aqueous anticaking agent solution has a water content in solution of from 40% to 70%; or wherein the aqueous anticaking agent solution has a water content in solution of from 40% to 60%; or wherein the aqueous anticaking agent solution has a water content in solution of from 40% to 50%.

Example 27. The aqueous anticaking agent solution of any one of examples 23-26, wherein the aqueous anticaking agent solution is stable at 23° C. for at least 14 days; or wherein the aqueous anticaking agent solution is stable at 23° C. for at least 21 days; or wherein the aqueous anticaking agent solution is stable at 23° C. for at least 28 days.

Example 28. The aqueous anticaking agent solution of any one of examples 23-27, wherein the aqueous anticaking agent solution further comprises additional hydroxypolycarboxylic acid species other than citrate, wherein no more than about 10% of the hydroxypolycarboxylic acid species in the aqueous anticaking agent solution are hydroxypolycarboxylic acid species other than citrate; or wherein no more than about 5% of the hydroxypolycarboxylic acid species in the aqueous anticaking agent solution are hydroxypolycarboxylic acid species other than citrate.

Example 29. The aqueous anticaking agent solution of any one of examples 23-27, wherein the only hydroxypolycarboxylic acid species in the aqueous anticaking agent solution are citrate species.

Example 30. The aqueous anticaking agent solution of any one of examples 23-27, wherein the only carboxylic acid species in the aqueous anticaking agent solution are citrate species.

Example 31. The aqueous anticaking agent solution of any one of examples 23-30, wherein the aqueous anticaking agent solution described herein exhibits a Relative Caking Value when applied at an application rate of 10 mg Fe per kg untreated salt that is the same or less than the Relative Caking Value of the 1% TCP Standard, as evaluated under the Standard Anti-Caking Test.

Example 32. The aqueous anticaking agent solution of any one of examples 23-31, wherein the aqueous anticaking agent solution is substantially free of heavy metals.

Example 33. A method of treating salt comprising: providing an untreated salt composition comprising sodium chloride, and applying the aqueous anticaking agent solution of any one of examples 23-32 to the untreated salt composition in an amount effective to reduce caking of the salt.

Example 34. The method of example 33, wherein the untreated salt composition has a surface moisture content of no more than 0.03%.

Example 35. The method of examples 33 or 34, wherein the aqueous anticaking agent solution is applied at an application rate of from 0.5 mg Fe per kg salt to 200 mg Fe per kg salt; or wherein the aqueous anticaking agent solution is applied at an application rate of from 2 mg Fe per kg salt to 200 mg Fe per kg salt; or wherein the aqueous anticaking agent solution is applied at an application rate of from 5 mg Fe per kg salt to 150 mg Fe per kg salt; or wherein the aqueous anticaking agent solution is applied at an application rate of from 5 mg Fe per kg salt to 100 mg Fe per kg salt; or wherein the aqueous anticaking agent solution is applied at an application rate of from 5 mg Fe per kg salt to 50 mg Fe per kg salt.

Example 36. The aqueous anticaking agent solution in any of the preceding examples, wherein the anticaking agent in the aqueous anticaking agent solution comprises iron citrate complexation compounds of iron(II) and iron(III) having a citrate ionization ≥3.5 but ≤4.0; ≥3.5 and ≤4.0; ≥3.5 and ≤4.0; ≥3.0 and ≤4.0; ≥3.6 and ≤3.9; ≥3.7 and ≤4; ≥3.5 and ≤3.9; ≥3.5 and ≤4.0.

Example 37. The anticaking agent in any of the preceding examples, wherein the anticaking agent comprises one or more iron citrate complexation compounds having the formula Naₓ₊₁FeC₆H₅₋ₓO₇, where x=0.5 to 1.0.

Example 38. The anticaking agent of example 38, wherein the average molecular weight of the one or more iron citrate complexation compounds is in the range of 278.93-289.92 g/mol.

Example 39. The method, anticaking agent, or aqueous anticaking agent solution in any of the preceding examples, wherein the anticaking agent or aqueous anticaking agent solution is free of meso-tartrate anions and/or meso-tartrate compounds.

Example 40. The method of any of the preceding examples, further comprising a filtration step to remove particulates from the aqueous anticaking agent solution.

Example 41. The method or aqueous anticaking agent solution of any of the preceding examples, wherein the aqueous anticaking agent solution is substantially free of particulates.

Throughout this specification and claims, unless the context requires otherwise, the word “comprise”, and variations such as “comprises” and “comprising”, will be understood to imply the inclusion of a stated integer or step or group of integers or steps but not the exclusion of any other integer or step or group of integer or step. When used herein “consisting of” excludes any element, step, or ingredient not specified in the claim element. When used herein, “consisting essentially of” does not exclude materials or steps that do not materially affect the basic and novel characteristics of the claim. In the present disclosure of various embodiments, any of the terms “comprising”, “consisting essentially of” and “consisting of” used in the description of an embodiment may be replaced with either of the other two terms.

All patents, patent applications (including provisional applications), and publications cited herein are incorporated by reference as if individually incorporated for all purposes. Unless otherwise indicated, all parts and percentages are by weight and all molecular weights are weight average molecular weights. The foregoing detailed description has been given for clarity of understanding only. No unnecessary limitations are to be understood therefrom. The invention is not limited to the exact details shown and described, for variations obvious to one skilled in the art will be included within the invention defined by the claims.

1. A method of making an aqueous anticaking agent solution comprising
mixing a ferrous source, a citrate source, a hydroxide source and water together to form an intermediate aqueous mixture, wherein the ferrous source and the citrate source are present in a Fe to citrate molar ratio of from 0.5 to 1.5, and the hydroxide source is present in an amount to give a total hydroxide to citrate molar ratio of from (0.1+x) to (1.0+x), where x=the number of ionizable protons associated with the carboxylate sites on the citrate source;
allowing the ferrous source, citrate source, and hydroxide source to be present in the intermediate aqueous mixture for a time sufficient to form at least one soluble iron citrate complex to provide an aqueous anticaking agent solution.

2. A method of making an aqueous anticaking agent solution comprising
mixing a ferrous source, a citrate source, a hydroxide source and water together to form an intermediate aqueous mixture, wherein the ferrous source and the citrate source are present in a Fe to citrate molar ratio of from 0.5 to 1.5, and the hydroxide source is present in an amount such that the intermediate aqueous mixture has a pH at the time of mixing of at least 5;
allowing the ferrous source, citrate source, and hydroxide source to be present in the intermediate aqueous mixture for a time sufficient to form at least one soluble iron citrate complex to provide an aqueous anticaking agent solution.

3. The method of claim 1, wherein the ferrous source and the citrate source are present in the intermediate aqueous mixture in a Fe to citrate molar ratio of from 0.8 to 1.3.

4. The method of claim 1, wherein the intermediate aqueous mixture has a pH at the time of mixing of from 5 to 10.

5-8. (canceled)

9. The method of claim 1, wherein the ferrous source is selected from the group consisting of ferrous chloride, ferrous sulfate, ferrous nitrate, ferrous acetate, ferrous hydroxide, and mixtures thereof.

10. The method of claim 1, wherein the citrate source is selected from the group consisting of trisodium citrate, monosodium citrate, disodium citrate, monopotassium citrate, dipotassium citrate, tripotassium citrate, citric acid, monoammonium citrate, diammonium citrate, triammonium citrate, calcium citrate, magnesium citrate and mixtures thereof.

11. (canceled)

12. The method of claim 1, wherein the hydroxide source is selected from the group consisting of sodium hydroxide, potassium hydroxide, ammonium hydroxide and mixtures thereof.

13. (canceled)

14. The method of claim 1, further comprising cooling the aqueous anticaking agent solution and removing any precipitate that has formed.

15. The method of claim 1, wherein the solution is heated while mixing the ferrous source, the citrate source, the hydroxide source and water together.

16. The method of claim 1, wherein the total concentration of Fe present in the aqueous anticaking agent solution is at least 24,000 ppm Fe.

17. The method of claim 1, wherein the aqueous anticaking agent solution is stable at 23° C. for at least 1 hour.

18. The method of claim 1, wherein the aqueous anticaking agent solution has a water content in solution of from 30% to 85%.

19. The method of claim 1, wherein the aqueous anticaking agent solution further comprises additional hydroxypolycarboxylic acid species other than citrate, wherein no more than about 10% of the hydroxypolycarboxylic acid species in the aqueous anticaking agent solution are hydroxypolycarboxylic acid species other than citrate.

20. The method of claim 1, wherein the aqueous anticaking agent solution further comprises additional carboxylic acid species other than citrate, wherein no more than about 10% of the carboxylic acid species in the aqueous anticaking agent solution are carboxylic acid species other than citrate.

21. (canceled)

22. An aqueous anticaking agent solution prepared by the method of claim 1.

23. The aqueous anticaking agent solution in claim 1, wherein the aqueous anticaking agent solution comprises one or more iron citrate complexes of iron(II) and iron(III) having a citrate ionization ≥3.5 but ≤4.0.

24. The method of claim 1, wherein the anticaking agent solution is free of meso-tartrate anions and/or meso-tartrate compounds.

25. The method of claim 1, wherein the hydroxide source is present in an amount to give a total hydroxide to citrate molar ratio of from (0.5+x) to (1.0+x), where x=the number of ionizable protons associated with the carboxylate sites on the citrate source.

26. A method of making a salt composition comprising applying an anticaking agent solution prepared by the method of claim 1 to a dry salt composition comprising sodium chloride.

27. The method of claim 26 wherein the anticaking solution is applied to the dry salt composition at an application rate of from 0.5-200 mg of Fe per kilogram of the dry salt composition.
